(19) United States
(12) Patent Application Publication
(10) Pub. No.: US 2016/0371786 A1
(43) Pub. Date: Dec. 22, 2016

(54) METHOD AND SYSTEM TO OBTAIN AND MANAGE MEDICAL RECORDS

(71) Applicant: CERNER INNOVATION, INC., KANSAS CITY, KS (US)

(72) Inventors: BRUCE HOWARD KUSENS, NORTH MIAMI BEACH, FL (US); MICHAEL KUSENS, COOPER CITY, FL (US)

(21) Appl. No.: 15/186,392

(22) Filed: Jun. 17, 2016

Related U.S. Application Data
(60) Provisional application No. 62/181,811, filed on Jun. 19, 2015.

(51) Int. Cl. G06Q 40/08; G06F 19/00

(52) U.S. Cl. CPC G06Q 40/08; G06F 19/322

(57) ABSTRACT

Systems and methods obtain credentials from an insurance policy applicant to access one or more third party medical record sources holding medical records related to the insurance policy applicant. The systems and methods may automatically retrieve the relevant medical records, and may further provide the applicant an opportunity to comment on the retrieved records and/or add relevant documents or files before transmitting the medical records to a medical record recipient, such as an insurance underwriter.

### CROSS-REFERENCE TO RELATED APPLICATIONS

This application claims the benefit of U.S. Provisional Application No. 62/181,811, filed Jun. 19, 2015, which is hereby incorporated by reference in its entirety.

### TECHNICAL FIELD

The present invention relates to obtaining and managing medical records, particularly for non-medical purposes, more particularly for the purposes of insurance underwriting.

### BACKGROUND

In the current environment approximately 291 million life insurance policies are in force, representing over $18 Trillion dollars of total policy value in the United States alone. Additionally, each year over 29 million new life insurance policies are purchased with a total policy value of approximately $2.9 Trillion dollars, each of which has undergone some type of insurance underwriting process prior to being offered for purchase by the insurance companies. Typically, the insurance underwriting process begins with an applicant requesting to purchase an insurance policy, whether for life, disability or some other type of medically underwritten policy. As part of the application process, the insurance underwriter will gather many types of information including, but not limited to, medical, financial and familial history about the applicant in order to make a determination of insurability and risk associated with any given applicant.

Obtaining this information from various sources, especially information subject to strict privacy regulations such as health information, can be a complex and time consuming process often resulting in substantial delays and costs in processing an insurance application. A cursory review of various insurance companies' estimates for the time to process a medically underwritten policy reveal time frames ranging from several weeks to several months, with the factor contributing the most time and variability being obtaining medical records from various sources and the necessary consents from the applicant to request the records in the first place.

### BRIEF SUMMARY

The present invention generally relates to obtaining and managing medical records, particularly for non-medical purposes, more particularly for the purposes of insurance underwriting. This Brief Summary is provided as an overview of selected aspects of the disclosure that are described in greater detail in the description that follows, inclusive of the figures. This Brief Summary is not meant to define the invention or the claims in isolation from the remainder of the disclosure.

In some aspects, this disclosure relates to a method for obtaining medical records. The method may comprise receiving, by an electronic medical record consent system and from an insurance policy applicant, one or more credentials needed to access medical records for the insurance policy applicant from a third party medical record source. The method may comprise using the received one or more credentials to electronically retrieve one or more medical records for the insurance policy applicant from the third party medical record source by a medical record retrieval system. The method may comprise storing the one or more medical records in a medical record database.

The medical records may be retrieved by downloading one or more documents or files from the third party medical record source. The medical records may be retrieved by scraping information from one or more databases or information outputs accessed from the medical record source.

The method may comprise electronically notifying the insurance policy applicant that retrieved medical records are available for review by the insurance policy applicant. The method may comprise electronically analyzing the retrieved medical records, by the medical record review system. The method may comprise electronically identifying, by the medical record review system, possible discrepancies for human user review. The method may comprise electronically receiving additional information from the insurance policy applicant. The additional information may comprise comments related to the retrieved medical records. The additional information may comprise documents or files uploaded by the insurance policy applicant. The method may comprise electronically storing the additional information from the insurance policy applicant in the medical record database. The method may comprise electronically transmitting at least a portion of the retrieved medical records to a medical record recipient by a medical record transmission system.

The method may comprise using the received one or more credentials to electronically retrieve one or more medical records for the insurance policy applicant from the third party medical record source by a medical record retrieval system. The method may comprise formatting, by the medical record transmission system, at least a portion of the retrieved medical records prior to transmitting the retrieved medical records to the medical record recipient. The formatting may comprise changing the file type used to store the retrieved medical records. The formatting may comprise generating a new file using information from the retrieved medical records. The method may comprise generating a log entry for each transmission of retrieved medical records. The method may comprise storing the log entry in the medical records database.

In some aspects, this disclosure relates to a computerized system for obtaining medical records. The system may comprise a medical record consent system configured to receive from an insurance policy applicant one or more credentials needed to access medical records for the insurance policy applicant from a third party medical record source. The system may comprise a medical record retrieval system configured to use the one or more credentials to electronically receive one or more medical records for the insurance policy applicant from the third party medical record source. The system may comprise a medical record database for storing the one or more medical records.

The system may comprise a medical record review system configured to notify the insurance policy applicant of receipt of medical records from the third party medical record source. The medical record review system may be further configured to permit the insurance policy applicant to provide additional information. The medical record review system may be configured to analyze retrieved medical records and identify possible discrepancies for human user review. The system may comprise a medical record transmission system configured to transmit at least a portion of the retrieved medical records to a medical record recipient. The medical record transmission system may be configured to reformat at least a portion of the medical records prior to transmitting the at least a portion of the medical records to the medical record recipient.

Additional objects, advantages, and novel features of the invention will be set forth in part in the description which follows, and in part will become apparent to those skilled in the art upon examination of the following, or may be learned by practice of the invention.

### BRIEF DESCRIPTION OF THE DRAWINGS

This disclosure references the attached drawing figures, wherein:

FIG. 1 is an exemplary computing environment useful in the practice of the disclosure;

FIG. 2 is an exemplary workflow for obtaining and managing medical records;

FIG. 3 is a flowchart of an exemplary process for an applicant to provide consent related to medical record access and transfers, supply credentials for accessing electronic medical records and/or verify the credentials;

FIG. 4 is a flowchart of an exemplary process for retrieving and/or storing an applicant's medical records;

FIG. 5 is a flowchart of an exemplary process for an applicant to review retrieved records; and

FIG. 6 is a flowchart of an exemplary process for transmitting medical records to a third party.

### DETAILED DESCRIPTION

As used herein, an “applicant” is an individual, or a legally authorized representative of the individual, who applies for life, disability, or other medically underwritten insurance coverage.

As used herein, a “medical record” is a record of medical care for a given patient, possibly including, but not limited to, allergies, immunizations, medication history, lab results, radiological readings, procedure history, diagnosis history, surgical history, and personal health records.

As used herein, a “medical record source” is a person, company, organization, government entity, or other entity that stores clinical information about a specific patient. Exemplary medical record sources include, but are not limited to, insurance companies, pharmacies, hospital systems, personal health record applications, laboratories, and doctor's offices.

As used herein, “medical record consent system” refers to a computer system specifically programmed to permit an applicant to consent to the release of the applicant's medical records from one or more medical record sources. The medical record consent system may provide electronic credentials for accessing the applicant's medical records from the medical record sources' computer systems.

As used herein, “medical record retrieval system” refers to a computer system specifically programmed to electronically verify electronic credentials provided by an applicant and to electronically retrieve available medical records for each medical record source for which credentials were supplied and verified. The credentials may be provided, electronically or manually, by the applicant to a third party needing or wishing to review the applicant's medical records, such as an insurance underwriter. By providing electronic credentials and allowing the third party to retrieve the applicant's medical records, time and labor demands for the third party for gathering medical records should be reduced. The applicant might supply credentials through software associated with a medical record consent system, or the underwriter or other third party might enter the credentials after the underwriter or other third party receives the credentials from the applicant. A medical record retrieval system may be programmed to automatically attempt to login to the applicant's account for a particular medical record source to electronically verify the credentials and/or to automatically and electronically retrieve the applicant's medical records stored by the medical record source for the applicant. In some instances, the medical records may be provided in a downloadable format, and the medical record retrieval system may be programmed to electronically download the records. In some instances, the medical record retrieval system may be programmed to perform an electronic “screen scrape” to obtain from a website or other user interface the information contained in the medical records for the applicant. The medical record retrieval system may be programmed to electronically send the medical records obtained by the system to the applicant for review and, optionally, comment, prior to the system electronically sending the medical records to the underwriter or other third party. In addition to or instead of sending the record or records themselves for the applicant's or third party's review, the system may send an electronic notification, possibly including a link, to the applicant and/or third party, such that when the applicant and/or third party clicks on the link the applicant and/or third party can view and/or download the medical records. The records retrieved by the medical record retrieval system may be stored in a medical record system database. Electronic notification might be sent to the applicant at the time, or shortly after the time, that the medical records are retrieved by the medical record retrieval system. Electronic notification might be sent to the third party after the applicant has confirmed that the applicant has reviewed the retrieved medical record(s) and, optionally, provided any comments or documents to include with the medical record(s), or after the applicant has indicated that the applicant waives reviewing the medical record(s).

As used herein, “medical record database” refers to an electronic database that stores applicants' retrieved medical records and any subsequent changes, additions or clarifications to an applicant's medical records by the applicant or by the original medical record source.

As used herein, “medical record review system” refers to a computer system programmed to permit an applicant to review, add, dispute, or provide clarification or context to the applicant's medical records.

As used herein, a “medical record transmission system” refers to computer system programmed to securely transmit an applicant's retrieved, reviewed and amended medical records to authorized medical record recipients, such as an insurance underwriter for a given applicant's policy or applied-for policy.

As used herein, “medical record recipient” refers to a person, company, organization, government entity, or other entity that reviews medical records and/or other records as part of an insurance underwriting process.

In general, an applicant may establish access to a medical records retrieval system and be issued credentials upon completion of identity verification. The verification process may occur at any time, and may be initiated by a patient/applicant, a healthcare provider, or another individual authorized by the patient/applicant, such as a financial planner or attorney. In some instances, the credentialing process may begin upon a patient/applicant's registration or check-in with a health care provider or other service provider. The provider can introduce the medical records retrieval system to the patient, or the patient may use the system and request the provider's participation.

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

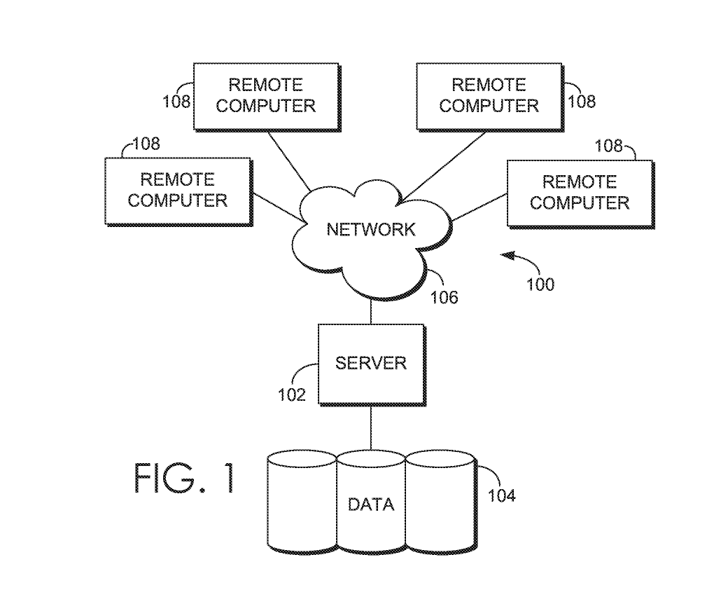

Referring to the drawings in general, and initially to FIG. 1 in particular, an exemplary computing system environment, for instance, a medical and/or insurance information computing system, on which embodiments of the present invention may be implemented is illustrated and designated generally as reference numeral 100. It will be understood and appreciated by those of ordinary skill in the art that the illustrated medical information computing system environment 100 is merely an example of one suitable computing environment and is not intended to suggest any limitation as to the scope of use or functionality of the invention. Neither should the medical information computing system environment 100 be interpreted as having any dependency or requirement relating to any single component/module or combination of components/modules illustrated therein.

Embodiments of the present invention may be operational with numerous other general purpose or special purpose computing system environments or configurations. Examples of well-known computing systems, environments, and/or configurations that may be suitable for use with embodiments of the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

Embodiments of the present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary medical information computing system environment 100 includes a general purpose computing device in the form of a server 102. Components of the server 102 may include, without limitation, a processing unit, internal system memory, and a suitable system bus for coupling various system components, including database cluster 104, with the server 102. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The server 102 typically includes, or has access to, a variety of computer-readable media, for instance, database cluster 104. Computer-readable media can be any available media that may be accessed by server 102, and includes volatile and nonvolatile media, as well as removable and non-removable media. By way of example, and not limitation, computer-readable media may include computer storage media and communication media. Computer storage media may include, without limitation, volatile and nonvolatile media, as well as removable and non-removable media implemented in any method or technology for storage of information, such as computer-readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the server 102. Communication media typically embodies computer-readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

The computer storage media discussed above and illustrated in FIG. 1, including database cluster 104, provide storage of computer-readable instructions, data structures, program modules, and other data for the server 102.

The server 102 may operate in a computer network 106 using logical connections to one or more remote computers 108. Remote computers 108 may be located at a variety of locations in a medical or research environment, for example, but not limited to, clinical laboratories, hospitals and other inpatient settings, veterinary environments, ambulatory settings, medical billing and financial offices, hospital administration settings, home health care environments, and clinicians' offices, as well as insurance companies or other relevant business or medical environments. The remote computers 108 may also be physically located in non-traditional medical care environments so that the entire health care community may be capable of integration on the network 106. The remote computers 108 may be personal computers, servers, routers, network PCs, peer devices, other common network nodes, or the like, and may include some or all of the elements described above in relation to the server 102. The devices can be personal digital assistants or other like devices.

Exemplary computer networks 106 may include, without limitation, local area networks (LANs) and/or wide area networks (WANs). Such networking environments are commonplace in offices, enterprise-wide computer networks, intranets, and the Internet. When utilized in a WAN networking environment, the server 102 may include a modem or other means for establishing communications over the WAN, such as the Internet. In a networked environment, program modules or portions thereof may be stored in the server 102, in the database cluster 104, or on any of the remote computers 108. For example, and not by way of limitation, various application programs may reside on the memory associated with any one or more of the remote computers 108. It will be appreciated by those of ordinary skill in the art that the network connections shown are exemplary and other means of establishing a communications link between the computers (e.g., server 102 and remote computers 108) may be utilized.

In operation, a user may enter commands and information into the server 102 or convey the commands and information to the server 102 via one or more of the remote computers 108 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the server 102. In addition to a monitor, the server 102 and/or remote computers 108 may include other peripheral output devices, such as speakers and a printer.

Although many other internal components of the server 102 and the remote computers 108 are not shown, those of ordinary skill in the art will appreciate that such components and their interconnection are well known. Accordingly, additional details concerning the internal construction of the server 102 and the remote computers 108 are not further disclosed herein.

Although methods and systems of embodiments of the present invention are described as being implemented in a WINDOWS operating system, operating in conjunction with an Internet-based system, one of ordinary skill in the art will recognize that the described methods and systems can be implemented in any system supporting the automated configuration, implementation and/or maintenance of a healthcare information system. As contemplated by the language above, the methods and systems of embodiments of the present invention may also be implemented on a stand-alone desktop, personal computer, or any other computing device used in a healthcare environment or any of a number of other locations.

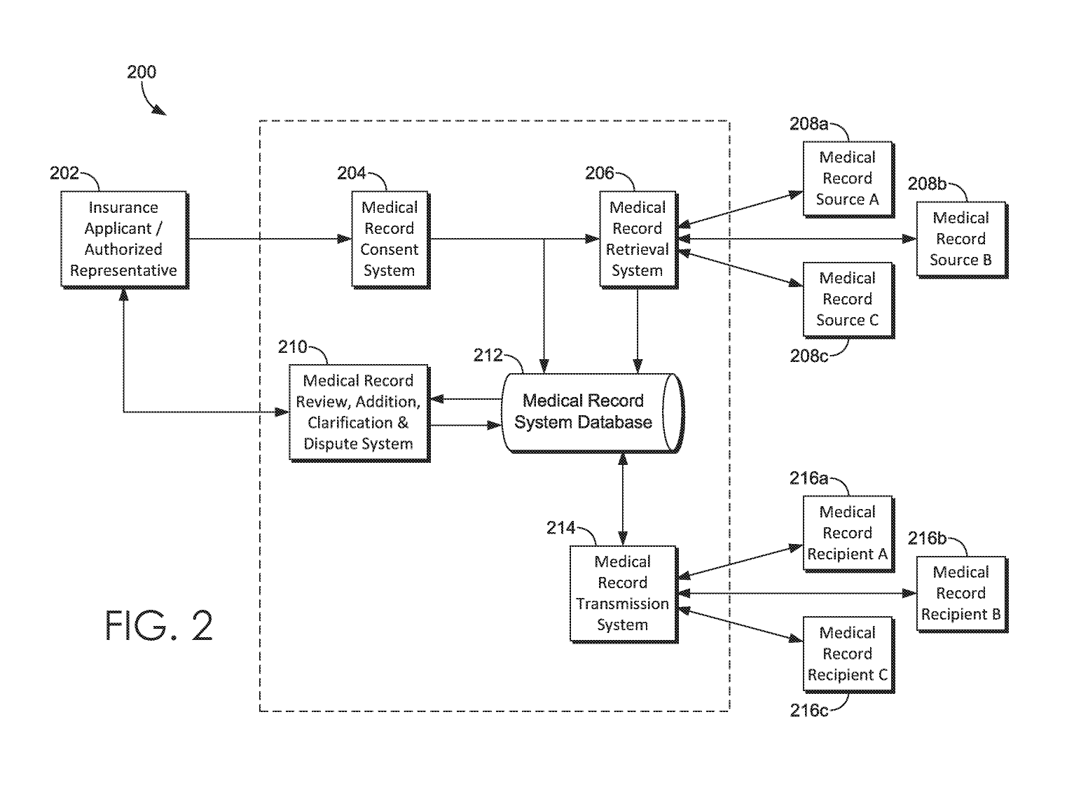

FIG. 2 shows an exemplary process 200 for obtaining and managing medical records. While this figure is representative of a high-level overview of the system, not all routines, algorithms or sub-routines of this method or interfaces are disclosed within this figure. An applicant 202 begins a session on the medical record consent system 204, where the applicant may provide consent to retrieve, review and transmit the applicant's medical records to insurance underwriters of the applicant's choice. As part of this process, the applicant may provide previously established authorization credentials for accessing one or more medical record source systems, as might be needed to electronically access the medially record source systems to view and/or retrieve the applicant's medical records. Exemplary credentials may include, but are not limited to, usernames, passwords and answers to security questions for access to the medical record sources system. The medical record consent system 204 may pass the applicant's supplied credentials to the medical record retrieval system 206 for use in accessing the applicant's medical records from the one or more medical record source's system(s), such as medical record source systems 208a, 208b, and 208c. The applicant's consents and credentials may be stored in a medical record database 212.

The medical record retrieval system 206 may access the electronic portals of each medical record source for which electronic credentials have been supplied and authorization granted by the applicant, such as medical record sources 208a, 208b, and/or 208c. The supplied credentials are verified and the available medical records of interest, which may be all available medical records or a subset of available medical records, for which the applicant has authorized access, are retrieved and/or scraped to import the relevant information to the medical record retrieval system, as by storing the information in the medical record database. For each medical record source supported by the medical record consent system 204 and/or the medical record retrieval system 206, the system may be programmed to take into account any unique requirements of the computer system used by the medical records source. For example, a system may require a specific virtual private network (VPN) connection and credentials to access a certain source, or two-factor authentication, or that a request originate from a known IP address, or that a particular interface type or protocol be used. Alternately or in addition, different queries may be needed to identify and retrieve medical records that are stored in different file types and/or information formats. In some instances, the applicant 202 may provide a username and password to permit the medical record retrieval system 206 to retrieve the applicant's medical records from a health insurance company's system. In some instances, the medical records source may be a physician, such as a primary care physician, specialist, or other healthcare provider. In some instances, the medical records source may be a healthcare organization, such as a hospital or clinic. The medical record consent system 204 and/or medical record retrieval system 206 may be programmed to electronically set up access (e.g., an electronic system account) for the applicant with the applicant-identified medical record source(s), for example, if the applicant 202 has never registered for electronic access to his or her medical records from a particular medical record source(s). Records retrieved are stored in the medical records database 212. The records may be retrieved by downloading a file or document. The records may be retrieved by “scraping” information from a screen or other display or output device. To scrape a display or output, a computer program may read the display information, parse the data it encounters on the screen, and store the parsed information in a database.

The medical record review system 210 may notify the applicant 202 of the retrieved medical records. The applicant 202 may optionally access the medical record review system 210 to view any medical records retrieved and/or stored for the applicant 202. The applicant 202 may be permitted to view any or all of the retrieved records for the applicant, provide additional records, provide context or clarification to any aspect of any of the medical records, and/or dispute any of the information in the retrieved records. The medical record review system 210 may provide a user interface for the applicant 202 to provide additional information, including, as non-limiting examples, comments on documents or information retrieved, or new or different documents to supplement the documents and/or information retrieved. Electronic forms and/or electronic templates may be provided to allow the applicant 202 to provide additional information. Electronic tools may also be provided to allow the applicant 202 to add comments directly on a retrieved medical record.

The applicant 202 may be permitted to upload files from the applicant's computer for storage with the retrieved medical record on the medical record system database 212. In order to associate any files uploaded by the applicant 202 with the retrieved medical records for the applicant 202 in the medical record database 212, one or more identifiers for the applicant 202 can be used, such as demographic information. Non-limiting examples of demographic identifiers include name, birth date, social security number or part of a social security number, application number, account number with an insurance underwriter, etc., or combinations thereof. Any medical record additions, clarifications and/or disputes made by the applicant are stored in the medical record database 212 along with the original retrieved records. If the applicant 202 appends a medical record, the medical record review system 210 may notify the medical record source 208 and/or request clarification or confirmation from the medical record source. Alternately, or additionally, the medical record review system 210 may report or highlight appended medical records to the medical record recipient 216, to draw attention to those aspects of the medical record(s) that may need further attention. The medical record review system 210 may provide notifications to both the medical record source 208 and the medical record recipient 216. The medical record review system may provide notices for applicant comments, or for applicant additions, or for applicant disputes, or for any combination thereof.

Medical record review system 210 may further analyze the retrieved medical records, before, concurrent with, and/or after the applicant 202 review. For example, the medical record review system 210 may note missing, improbable, or contradictory information that would benefit from review and clarification, correction, and/or supplemental or contextual information. For example, the medical record review system may note that a medical record includes a diagnosis of cancer, but no biopsy results consistent with a cancer diagnosis. As another example, the medical record review system may note that a medical record indicates a patient's sex as female, but includes prostate exam findings. As other examples, the medical record review system may note that one or more routine physical exam findings, such as height, weight, blood pressure, temperature, or the like are missing from a record of a routine physical examination. The medical record review system may note entries in different medical records believed to be for the same patient that are improbable or contradictory, such as a height measure in one file of 150 cm and a height measure in a second file of 170 cm, or physical exam findings for a foot reported as amputated in an earlier-dated medical record. The medical record review system may highlight the missing, improbable, or contradictory review, e.g., visually, as by highlighting or changing the font of the unusual medical record entry, or may generate a list of unusual entries for review, or may generate a list of questions intended to solicit missing information or clarify uncertain information. If identified by the medical record review system 210, one or more unusual medical record entries or related questions may be displayed or transmitted to the applicant 202, the medical record source 208, the medical record recipient 216, or any combination thereof.

A medical record transmission system 214 may query the medical record database 212 for consent given by an applicant 202 to access one or more medical records for the applicant 202. The query may be made automatically in the course of a process. For example, the medical record transmission system 214 may query the medical record database 212 each time an applicant 202 reviews, declines to review, adds to, clarifies, or disputes a retrieved medical record. As another example, the medical record transmission system 214 may query the medical record database 212 if a certain amount of time has elapsed since the applicant 202 was notified a medical record was available for review, without regard to whether the applicant has acknowledged the notice or reviewed the record.

The consent(s) stored in the medical records database 212 may provide consent for the transmission of specific types of information and/or for transmission of information to specific medical record recipients 216. As one, non-limiting example, if an applicant challenges a record with a source, asserting that the record is inaccurate or misleading, for example, the applicant may provide consent to transmit the allegedly erroneous record back to the medical record source 208, and the applicant might or might not consent to transmit records related to the same condition, test, data, etc. that is being challenged; records unrelated to the challenge; and/or records from other medical sources with the allegedly erroneous record. If consent to access the documents has been provided, the medical record transmission system 214 may, if needed, reformat the medical record information (including, if applicable, any additions, clarifications and/or disputes added by the applicant) into a format accepted by the medical record recipient, such as medical record recipient(s) 216a, 216b, and/or 216b. The stored consent(s) can be reviewed and used to determine where to electronically send the retrieved medical records, e.g., to an insurance company, insurance underwriter, or other third party, after they are retrieved and, optionally, reviewed and/or appended by the applicant 202. In some instances, consent to transmit medical records may be available for only some of the retrieved medical records. For example, psychiatric records may be withheld. The stored consent(s) may provide information to the medical record transmission system 214 regarding any restrictions on the transmission or distribution of one or more retrieved medical records or retrieved medical record types (e.g., psychiatric medical records).

The reformatting, if needed, may include saving the medical records in a particular file format, such as doc, pdf, csv, txt, xls, xlm, etc.), or it may involve a conversion process whereby the medical record retrieval system and/or the medical record transmission system electronically parses the received data into a database, electronically determines the format required for a given underwriter, and electronically builds a file in the correct format, pulling information from the database where the original data is stored. The reformatted document(s) may be saved in the medical record database. Once reformatting is complete, if needed, the medical record transmission system may transmit the authorized medical record(s) for the applicant to the recipients for which the applicant has given consent to transmit the medical record(s).

Though shown as separate system blocks in FIG. 2, a single system can be provided that is configured and/or programmed to perform all of the functions of the various systems (e.g., medical records consent, medical records retrieval, medical record review, and medical record transmission) or any desired combination or sub-combinations thereof.

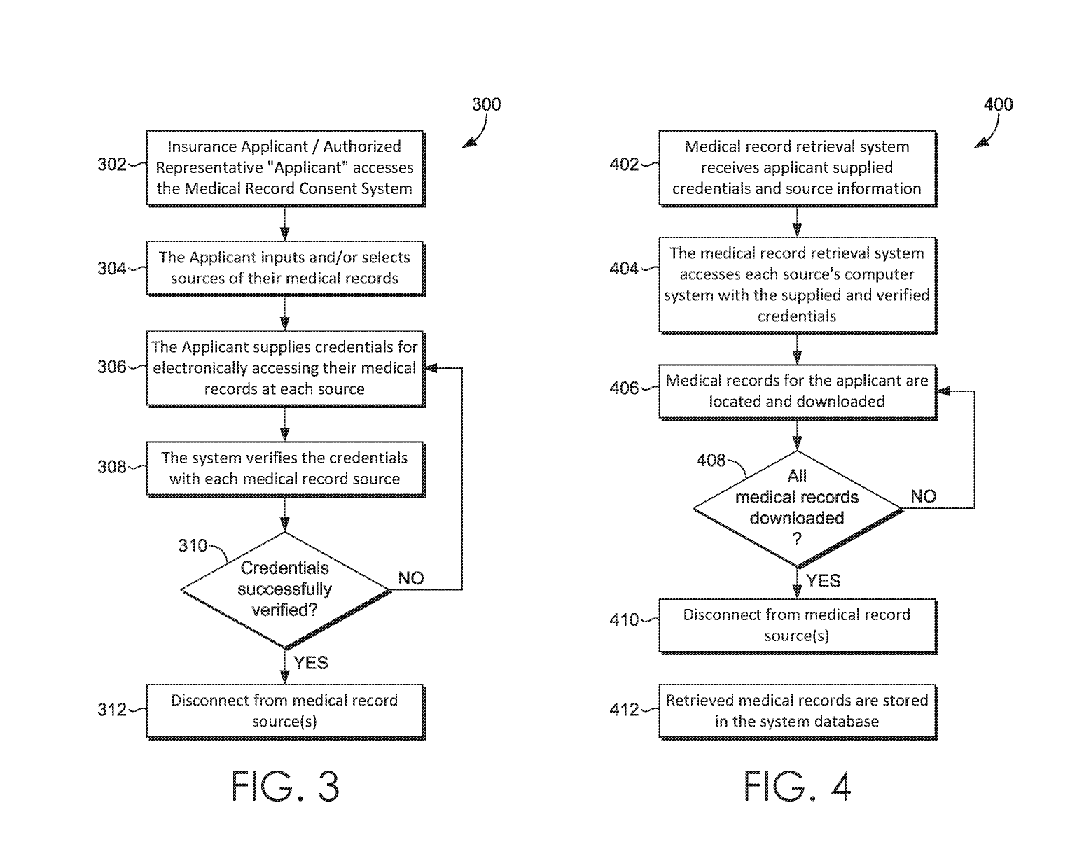

FIG. 3 shows an exemplary process 300 for an applicant to provide consent related to medical record access and transfers, supply credentials for accessing electronic medical records and/or verify the credentials. At step 302, the applicant may access a medical record consent system. The system might be accessed by an applicant using, for example, a computer, a notebook or laptop computer, a tablet computer, a smart phone, a smart watch, a kiosk, or a similar electronic device. At step 304, the applicant may be prompted to select or enter potential sources of medical records. Exemplary medical record sources include, but are not limited to, insurance companies, hospitals, doctors' offices, medical laboratories, medical imaging centers, pharmacies, medical clinics, urgent care facilities, other healthcare providers, and combinations thereof. A database or list of healthcare providers may be provided for the applicant to search, possibly filtering the names of the providers listed by, for example, zip code, the applicant's address, or other criteria, either identified from the applicant's records or entered by the applicant.

At step 306, the applicant may be prompted to supply credentials for accessing electronic medical records stored in each of the selected medical record sources' computer systems. Credentials might include a username, password, account number, and/or other information necessary to access the medical record sources' computer systems. At step 308, the medical record retrieval system may establish an electronic connection to one or more of, or to each of, the selected medical record sources. The credentials supplied by the applicant for each selected medical record source may be electronically inputted into the medical record sources' computer system interface (such as website or other user portal), and a determination may be made by the medical record source system as to whether the supplied credentials are valid. For example, the system may attempt to access the applicant's account and/or the applicant's medical records stored by the applicant's primary health insurer, e.g., by logging in to the insurer's website with the applicant-supplied credentials. Other exemplary third-party medical record sources that might be accessed include websites or portals for secondary health insurers, physicians' offices, hospitals, and the like. In some instances, the credential may be the applicant's user name and password, as the applicant would use to personally log in to the interface. In some instances, the credential may be a user name and password or alternate credential created for the purpose of facilitating access to retrieve medical records, as for life insurance underwriting. In some instances, the third party medical record source may provide access through an application programming interface (API) or other interface standards. At step 310, if credentials were not verified, the applicant may be prompted to review the supplied credentials and make any necessary changes. The process may then loop back to step 306 until the credentials are successfully verified or the source is unselected by the applicant.

At step 312, once the credentials for one or more or all of the selected medical record sources have been successfully verified, the medical record retrieval system may disconnect from the medical record source(s).

FIG. 4 shows an exemplary process 400 for retrieving and/or storing an applicant's medical records from selected medical records source(s). At step 402, the medical record retrieval system queries the database for an applicant's selected sources and, if required by a source, for the applicant's supplied credentials for the source. In some instances, the medical record retrieval system might not wait to later query the database, but may act on the applicant submitting or confirming a request to send medical records, as, for example, by clicking or selecting “enter,” “next,” or similar instruction or menu option on a screen associated with the medical record consent system. In other instances, the medical record retrieval system may be programmed to automatically act upon the receipt of a batch file with multiple applicants' consent to retrieve and/or transmit medical records.

At step 404, the medical record retrieval system may establish an electronic connection with each of the selected source(s) using the supplied credentials. If more than one source is queried, the system may establish multiple concurrent retrieval sessions or may query each source in succession, or may query groups of sources in succession, or may make the queries in any other order or grouping desired. At step 406, once a secure electronic connection is established and credentials are verified by the system, the medical record retrieval system queries the source(s) for available electronic medical record(s) of the applicant. The available medical record(s) may be downloaded and/or scraped from each of the selected sources. In some instances, a third party medical source system may present information over several files, pages, or displays, such as information organized on different tabs of a spreadsheet or different sub-sites of a website. In such cases, retrieving the medical record(s) from a single source may be an iterative process, requiring retrieving records from a first sub-source (such as a first tab or webpage) and at least a second sub-source (such as a second tab or webpage). In some instances, a third party medical source system may provide an option to download selected medical records or all medical records for a particular applicant or even medical records for two or more different applicants, combined into one or more summary files or documents that contain more than one medical record. At step 408, the medical record retrieval system may continue to query the selected sources. The medical record retrieval system may loop back to step 406 until all available medical record(s) have been downloaded and/or scraped. Some medical record sources may provide a single file or record to download and/or scrape, the single file or record containing all of the applicants' medical records. For medical record sources that do not provide downloadable files or a single comprehensive file, a software script can be used to read through the information and/or instructions presented by the medical record source's system in order to collect the requested record(s). At step 410, the medical record retrieval system may disconnect from each of the medical record source(s) as the available medical record(s) have been downloaded from each medical record source. At step 412, after disconnecting from the medical record source(s), the retrieved and/or scraped medical records may be stored in the medical record system database.

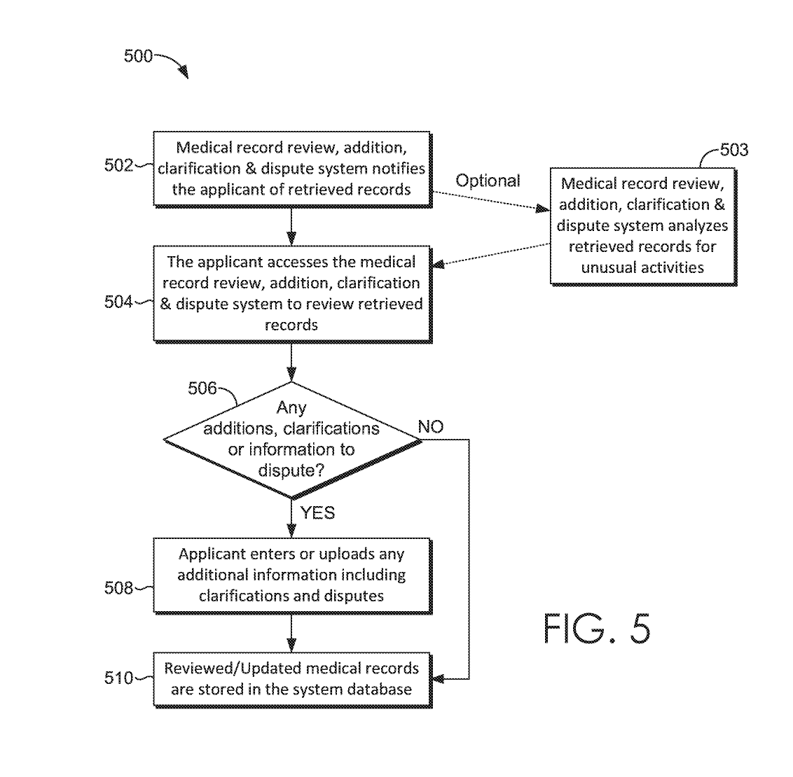

FIG. 5 shows an exemplary process 500 for an applicant to review retrieved records. The applicant may be permitted to provide additions or clarifications to, or to dispute the accuracy of, any information in the retrieved medical records. The applicant may be permitted to lodge additions, corrections and/or disputes before the retrieved medical records are transmitted and/or otherwise made available to medical record recipients, such as an insurance underwriter or other third party.

At step 502, the medical record review system may notify the applicant that records have been retrieved and are available for review. Exemplary notification methods include, without limitation, email, telephone, voice-mail, short-message-service (SMS), online notifications (as, for example, through an applicant interface, such as a web page or smart phone application), or other form of communication. Optionally, at step 503, the medical record review system may analyze the retrieved medical record(s) for missing, improbable, and/or contradictory information. Although step 503 is shown as occurring after the notification of the applicant that the medical record has been retrieved, step 503 could be performed before notifying the applicant. In some embodiments, the medical record review system may analyze a retrieved medical record and solicit correction or clarification for any unusual entries from the medical record source. The medical record source may be permitted to comment on or add information to the medical record(s) and/or the applicant's additional information, if the applicant has added additional information.

The applicant may be notified that the medical record was retrieved and is available for review before, concurrent with, or after analyzing the medical record and/or requesting additional information from the medical record source. Step 503 could alternately be performed and/or repeated after an applicant adds comments, additional information, or a dispute to a medical record, e.g., to check to see if the applicant's input has created any new missing, improbable, or contradictory entries. At step 504, the applicant may access the medical record review system to review any or all of the medical record(s) retrieved by the system. The applicant may access the system using any suitable device, such as a computer, notebook or laptop computer, tablet computer, smart phone, smart watch, or similar electronic device.

At step 506, if on review of the retrieved medical record(s) the applicant has no additions, clarifications or disputes regarding the information contained in the retrieved medical record(s), the process may proceed to step 510, where a notation is made in the system database. The applicant may terminate access to the medical record review system. At step 508, if the applicant does have additions, clarifications and/or disputes regarding the retrieved medical record(s), the applicant can enter information directly in the medical record review system and/or upload additional documents or files, such as supporting documentation. The applicant's comments and/or documents may be tied to the specific medical record(s) to which the applicant's comments and/or documents were directed, e.g., by appending the information directly to the specific medical record. Once any desired additions, clarifications and/or disputes are entered into the system by the applicant, the retrieved medical record may be updated and stored in the medical records database at step 510. The applicant may terminate access to the medical record review system.

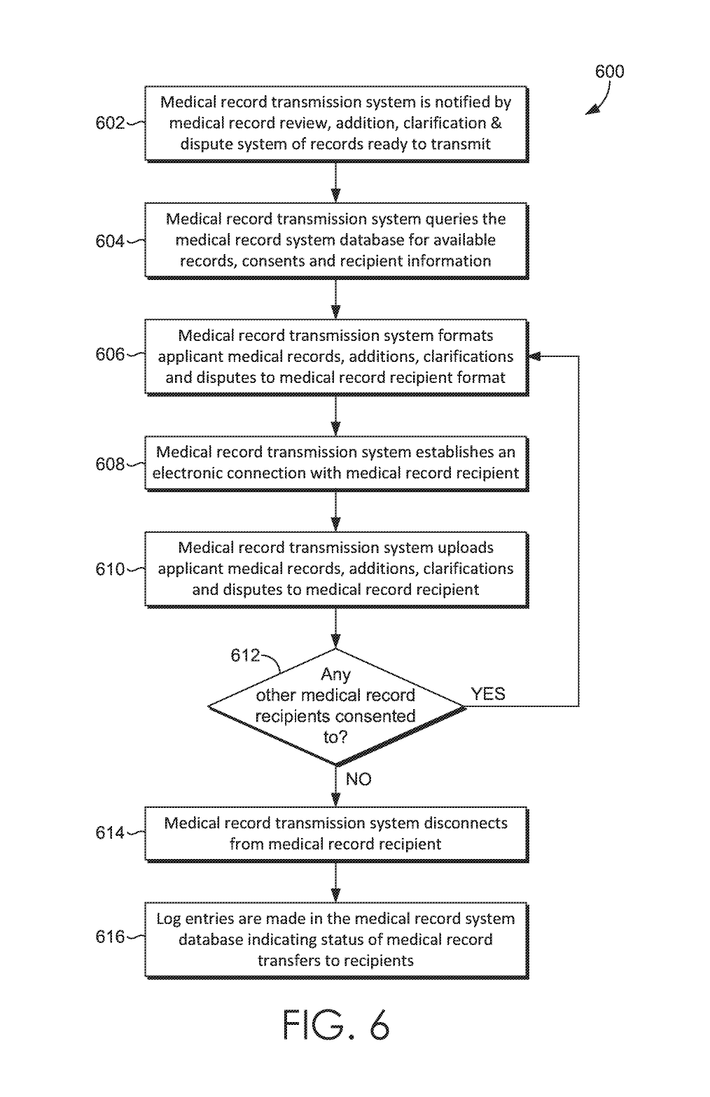

FIG. 6 shows an exemplary process 600 for transmitting medical records for an applicant to a third party, such as an insurance underwriter. The transmitted medical records may, optionally, include additions, clarifications, and/or disputes from an applicant regarding information in retrieved records, which may be documented as comments on a retrieved record or as a separate document or file uploaded to the medical information review system by the applicant, as described above.

At step 602, a medical record transmission system may receive an electronic notification from the medical record review system that an applicant's medical records have been reviewed, and, optionally, amended, by the applicant. Amendments may be optional at the determination of the applicant, at the determination of the medical record source, and/or at the determination of the medical record recipient. The notification indicates that the records are ready for transmission to recipients identified by the applicant. At step 604, the medical record transmission system may query the medical record system database for available medical record(s), with any amendments (e.g., additions, clarifications, and/or disputes) provided by the applicant as well as information regarding authorized recipients for the records. The recipient information may include, but is not limited to, the name of the recipient, a method of transmission, and/or credentials for accessing any electronic system of the recipient(s) that may be configured to receive electronic medical records.

At step 606, the medical record transmission system may format the applicant's medical records to comply with the format required and/or requested by a particular medical record recipient. Formatting a record may include, but is not limited to, changing the electronic file type (e.g., converting between doc, xlx, pdf, txt, csv, xlm, xls, and other file formats) and/or preparing a custom transmission file using data from the medical records database to build a new file by matching fields in the new file template to database fields in the medical record database. At step 608, using the transmission method(s) and credentials obtained in step 604, the medical record transmission system may establish a secure electronic connection with the medical record recipient(s)′ electronic system(s). At step 610, the medical record transmission system makes a determination of whether there are additional medical record recipients to transmit the applicant's medical records to. This determination may be based on the consents provided by the applicant. If there is another recipient the applicant has consented to send medical records to, the system may loop back to step 606. If there are no additional medical record recipients consented to by the applicant, the process continues to step 614.

At step 614, once the medical record transmission system has finished uploading the applicant's medical record(s) to an authorized medical record recipient, the medical record transmission system may disconnect from the medical record recipient's system. At step 616, the medical record transmission system may store a record of all transmissions in the medical record database. A transmission record may include, but it not limited to, the recipient of the records, the content of the transmission, and/or the dates and times of the medical record transmission.

As will be appreciated from the foregoing discussion, the system may comprise one or more of a medical record consent system, a medical record retrieval system, a medical record review system, a medical record transmission system, a medical record database, a network connection, and one or more human user input devices. The various components (possibly excluding the physical input device) may reside in a single physical unit, such as a single computer or a single computer server, or may be distributed over two or more computers or servers, which may be physically proximate or remote from one another, so long as they are in electrical communication with each other, whether by wired or wireless connections.

The systems and methods described may have one or more advantages over conventional systems and methods, including potentially significant reductions in administrative, clinical and financial resources required to collect a variety of medical records for a non-medical purpose, such as life insurance underwriting. A centralized system for management of applicant's record release consents may allow an applicant to request the transmission of medical records from a variety of sources in a single interaction (with a system or a person), rather than having to navigate multiple systems and/or manual processes. Automated medical record retrieval and transmission may expedite the making available of records for an underwriter's review, reducing underwriting time for insurance policies. A centralized system for recording amendments to a medical record may help an applicant maintain an error-free record and/or avoid likely questions by addressing them proactively, further reducing both the time for underwriting and the likelihood of errors in the underwriting process (as may occur based on errors in the underlying data). By consolidating information, including consents, medical records, and applicant addendums to the medical records, the system may reduce the processing capacity, communication bandwidth, and/or storage capacity required to retrieve potentially duplicative and/or error-containing records from a plurality of sources. By converting and/or creating file types as needed by particular recipient systems, the system may overcome incompatibilities that would otherwise prohibit the electronic transmission of the records and the attendant advantages to using electronic records. Automated analysis of the medical records for potential discrepancies and/or missing information may further accelerate the process, while also improving the accuracy and completeness of the information provided for underwriting.

From the foregoing, it will be seen that this disclosure is one well adapted to attain all the ends and objects hereinabove set forth together with other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative and not in a limiting sense.

What is claimed is:

1. A method for obtaining medical records, the method comprising:
receiving, by an electronic medical record consent system and from an insurance policy applicant, one or more credentials needed to access medical records for the insurance policy applicant from a third party medical record source;
using the received one or more credentials, electronically retrieving one or more medical records for the insurance policy applicant from the third party medical record source by a medical record retrieval system; and
storing the one or more medical records in a medical record database.

2. The method of claim 1, wherein the medical records are retrieved by downloading one or more documents or files from the third party medical record source.

3. The method of claim 1, wherein the medical records are retrieved by scraping information from one or more databases or information outputs accessed from the medical record source.

4. The method of claim 1, further comprising electronically notifying the insurance policy applicant that the retrieved medical records are available for review by the insurance policy applicant.

5. The method of claim 4, further comprising electronically analyzing the retrieved medical record, by the medical record review system, and identifying possible discrepancies for human user review.

6. The method of claim 5, further comprising electronically receiving additional information from the insurance policy applicant.

7. The method of claim 6, wherein the additional information comprises comments related to the retrieved medical records.

8. The method of claim 6, wherein the additional information comprises documents or files uploaded by the insurance policy applicant.

9. The method of claim 6, further comprising electronically storing the additional information from the insurance policy applicant in the medical record database.

10. The method of claim 9, further comprising electronically transmitting at least a portion of the retrieved medical records to a medical record recipient by a medical record transmission system.

11. The method of claim 1, further comprising electronically transmitting at least a portion of the retrieved medical records to a medical record recipient by a medical record transmission system.

12. The method of claim 11, further comprising formatting, by the medical record transmission system, at least a portion of the retrieved medical records prior to transmitting the retrieved medical records to the medical record recipient.

13. The method of claim 11, wherein the formatting comprises changing the file type used to store the retrieved medical records.

14. The method of claim 11, wherein the formatting comprises generating a new file using information from the retrieved medical records.

15. The method of claim 11, further comprising generating a log entry for each transmission of retrieved medical records and storing the log entry in the medical records database.

16. A computerized system for obtaining medical records, the system comprising:
a medical record consent system configured to receive from an insurance policy applicant one or more credentials needed to access medical records for the insurance policy applicant from a third party medical record source;
a medical record retrieval system configured to use the one or more credentials to electronically receive one or more medical records for the insurance policy applicant from the third party medical record source; and
a medical record database for storing the one or more medical records.

17. The system of claim 16, further comprising a medical record review system configured to notify the insurance policy applicant of receipt of medical records from the third party medical record source, and further configured to permit the insurance policy applicant to provide additional information.

18. The system of claim 17, wherein the medical record review system is further configured to analyze retrieved medical records and identify possible discrepancies for human user review.

19. The system of claim 18, further comprising a medical record transmission system configured to transmit at least a portion of the retrieved medical records to a medical record recipient.

20. The system of claim 19, wherein the medical record transmission system is further configured to reformat at least a portion of the medical records prior to transmitting the at least a portion of the medical records to the medical record recipient.
